(19) United States
(12) Patent Application Publication
(10) Pub. No.: US 2013/0022800 A1
(43) Pub. Date: Jan. 24, 2013

(54) SURFACE FILM OF THIN PLASTIC CASING COMPOSITE AND APPLICATION METHOD THEREOF

(71) Applicant: Ming-Jen Hsieh, Taiping City (TW)

(72) Inventor: Ming-Jen Hsieh, Taiping City (TW)

(73) Assignee: PAO YI TECHNOLOGY CO., LTD., Taiping City, Taichung County (TW)

(21) Appl. No.: 13/638,920

(22) PCT Filed: Apr. 19, 2010
(86) PCT No.: PCT/CN2010/000533

§ 371 Date: Oct. 1, 2012

(51) Int. Cl. B32B 7/02; B32B 5/00; B32B 25/08; B29C 45/14

(52) U.S. Cl. 428/215; 264/261

(57) ABSTRACT

A surface film of a thin plastic casing composite and an application method thereof are revealed. The surface film includes a decorative outer layer with a thickness of 0.2-0.6 mm, an intermediate heat absorption and insulation layer with a thickness of 0.2-0.5 mm, and an inner adhesive layer with a thickness of 40-60 μm. The layers are laminated to form a thin film. In use, set the surface in a cavity of an injection mold and form a thin plastic casing on the inner adhesive layer of the surface film to produce a composite. The thin plastic casing and the inner adhesive layer are melted and integrated by pressure and temperature of injection material. A part of the inner adhesive layer is infiltrated into pores of the intermediate heat absorption and insulation layer. Thus the connection strength and adhesion between the surface film and the thin plastic casing are increased.

### BACKGROUND OF THE INVENTION

1. Fields of the Invention

The present invention relates to a surface film of a thin plastic casing composite and an application method thereof, especially to a surface film that is mounted in an injection mold for injection of a thin plastic casing on the surface film thereof so as to form a composite with good adhesion, having the surface film and the thin plastic casing, and used as an housing of various products.

2. Descriptions of Related Art

There are various electronics available on the market including, but not limited to, computers such as notebook computers, communication products such as mobile phones, consumer products (so-called 3C products), etc. They all include a thin casing used as a housing that covers all the components therein. The structure of the thin casing varies according to the design requirements of the product. According to materials for a base of the thin casing, the thin casing includes two types-a thin plastic casing and a metal thin casing.

The thin plastic casing with a decorative outer surface is generally produced by in-mold decoration process (IMD). A substrate that is 3-dimensional and printed with figures such as a plastic film is mounted into a mold. The substrate (plastic film) is called IMD film hereafter. Then thermoplastic resin is injected by plastic injection molding technique to form a base of the casing on the rear side of the IMD film and the base is called resin base. The resin base and the IMD film are connected to form an integral thin plastic casing. The IMD film is fixed and connected to the outer surface of the resin base to form a permanent device. The IMD film is used as a decorative outer surface for the thin plastic casing, a protective surface for the thin plastic casing or both. Moreover, the protective surface for the can also be temporarily fixed on the outer surface of the resin base to form a temporary device. After completing the production, the IMD film is peeled off. The printed figures on the IMD film are transferred to or embossed on the outer surface of the resin base to form a decorative outer surface of the thin plastic casing.

There are many techniques related to the structure design and manufacturing method of the thin plastic casing mentioned above.

Refer to U.S. Pat. No. 3,654,062, a molded decorative plaque including a body portion of a plastic material and a facing sheet disposed over the front face of the body portion is produced by injection molding. The thermoplastic is injected into a mold on a rear side of the facing sheet. As to U.S. Pat. No. 6,117,384, a printed substrate with at least one color is fit into a mold and then a molten resin is injected into the mold cavity through gates behind the printed substrate to produce a one-piece permanently bonded three-dimensional product. In the U.S. Pat. No. 4,391,954, a thermoplastic molding composition comprising an aromatic carbonate polymer and a polyester derived from a cycleohexanedimethanol is revealed. The U.S. Pat. No. 6,465,102 reveals an article that includes a formed polymeric base with a decorative surface area and a process for making the molded structure. The polymeric base comprises a transparent cycloaliphatic polyester resin that is free from an aromatic moiety and the method of molding thereof. In the U.S. Pat. No. 6,117,384, an improved in-mold decorating process (IMD) for the manufacture of plastic articles is disclosed while the U.S. Pat. No. 6,136,441 reveals techniques related to multilayer plastic articles. Refer to the patents that reveal structure design or manufacturing method related to the plastic housing mentioned above, it is learned that most of the techniques place a further limitation on the IMD film and the resin base respectively. For example, the IMD film or the resin base is restricted to be made from plastic with a specific chemical group. Thus an integral composite plastic board in which the film and the base are connected firmly and difficult to peel off is produced. Each patent is distinctive from other patents.

However, when the IMD film and/or the resin base of a composite are/is placed with a further limitation, not only the materials used are restricted, the applications of the IMD film and/or the thin plastic casing are also limited. This has negative effect on the applications of the produced composite having the film and the thin plastic casing. For example, once users want to use different materials to produce the film such as fabric, leather, resin fiber, etc for diversity of products, the same technique or equipment is unable to be used for manufacturing the products with high production efficiency, ease in mass production, and good quality control. Thus the use efficiency and applications of the composite, the plastic housing, are unable to be improved. These are disadvantages of the above composite.

The applications of the composite formed by the film and the thin plastic casing available now do have some problems. Thus the present invention provides an effective solution that overcomes shortcomings of the techniques revealed in U.S. Pat. No. 3,654,062, U.S. Pat. No. 4,391,954, U.S. Pat. No. 6,465,102, U.S. Pat. No. 6,117,384, and U.S. Pat. No. 6,136,441.

### SUMMARY OF THE INVENTION

Therefore it is a primary object of the present invention to provide a surface film of a thin plastic casing composite and an application method thereof that improves connection strength and adhesion between a surface film and a thin plastic casing so as to increase molding quality and applications of the thin plastic casing composite.

In order to achieve the above object, a surface film of a thin plastic casing composite features on that: the surface film is used to be mounted into a cavity of a plastic injection mold for production of a thin plastic casing composite having the surface film and a thin plastic casing integrated with each other. The surface film consists of a decorative outer layer 11, an intermediate heat absorption and insulation layer 12 and an inner adhesive layer 13 from outside to inside. These layers are stacked and laminated to form a thin film.

The decorative outer layer is a fabric layer made from natural or artificial fiber, a synthetic leather layer formed by a synthetic leather, a carbon fiber layer made from carbon fiber or a glass fiber layer formed by glass fiber. The thickness of the decorative outer layer is about 0.2-0.6 mm.

The intermediate heat absorption and insulation layer 12 is made from polyester (tetoron), nylon or blends and is with a thickness of about 0.2-0.5 mm.

The inner adhesive layer is a thermoplastic rubber layer synthesized by butadiene-styrene block copolymer and hydrocarbon petroleum resin with a thickness of about 40-60 μm.

While in use, the surface film is set in a cavity of an injection mold. Then inject a thin plastic casing on the inner adhesive layer of the surface film to produce a thin plastic casing composite having the surface film and the thin plastic casing.

By injection pressure and temperature of injection material, the thin plastic casing and the inner adhesive layer are melted and integrated with each other. At the same time, a part of the thickness of the inner adhesive layer is infiltrated into the intermediate heat absorption and insulation layer to redistribute the injection pressure and temperature of the injection material and connect the thin plastic casing and the surface film. Thus an integral thin plastic casing composite is formed.

The intermediate heat absorption and insulation layer is in the form of woven fabric, non-woven fabric, a foam layer, or a microfiber layer.

The intermediate heat absorption and insulation layer and the decorative outer layer are adhered and integrated with each other. The inner adhesive layer is attached to an inner surface of the intermediate heat absorption and insulation layer by hot pressing of a roller.

A part of the thickness of the inner adhesive layer is 10-20% of the thickness, 4-12 μm.

The decorative outer layer is a fabric layer made from natural fiber such as vegetable fiber including cotton or hemp, or animal fiber including wool or silk.

The decorative outer layer is a fabric layer made from artificial fiber including nylon, polyester, acrylic fiber or blends.

The decorative outer layer is a synthetic leather layer made from polyurethane (PU), polyvinyl chloride (PVC), or PU together with PVC.

The injection material for the thin plastic casing is one of the followings: acrylonitrile butadiene styrene (ABS), polycarbonate resin (PC), acrylic resin, and polyamide resin (nylon).

When the surface film is set into the cavity, an outer periphery of the surface film is over an outer boundary of the cavity. Moreover, the outer boundary of the cavity is over a boundary line of the thin plastic casing so as to form a material overflow area that is thin and around a periphery of the injection mold. A flash is formed on the thin plastic casing after the injection molding. The flash is formed by the material overflow area.

In order to achieve the above object, an application method of a surface film of a thin plastic casing composite according to the present invention is applied to produce a thin plastic casing composite having a surface film and a thin plastic casing connected and integrated with each other. The applications method includes following steps.

Provide a surface film as claimed from claim 1 to claim 10. The surface film includes a decorative outer layer 11, an intermediate absorption and heat insulation layer 12 and an inner adhesive layer.

Provide an injection mold of a thin plastic casing used for plastic injection molding and fix the surface film flatly in a cavity of the injection mold.

Then inject a thin plastic casing on an inner adhesive layer of the surface film by plastic injection molding. The thin plastic casing and the inner adhesive layer are melted and integrated with each other by injection pressure and temperature of injection material during injection molding. At the same time, a part of the thickness of the inner adhesive layer is forced to be infiltrated into the intermediate heat absorption and insulation layer. Thus the injected thin plastic casing and the surface film are connected to form a thin plastic casing composite by the inner adhesive layer.

Remove the injection mold to get a thin plastic casing composite after cooling. A flash is formed on edge of a boundary line of the thin plastic casing.

Finally, perform deflashing by cutting the flash along the boundary line of the thin plastic casing to produce a finished a thin plastic casing composite.

When the surface film is set into the cavity, an outer periphery of the surface film is over an outer boundary of the cavity. Moreover, the outer boundary of the cavity is over a boundary line of the thin plastic casing so as to form a material overflow area that is thin and around a periphery of the injection mold. A flash is formed on the thin plastic casing after the injection molding. The flash is formed by the material overflow area.

Compared with the techniques available now, the present invention has an advantage that the connection strength and adhesion between the surface film and the thin plastic casing are improved so as to increase the quality and simplify manufacturing processes.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic drawing showing structure of a surface film of a thin plastic casing composite according to the present invention;

FIG. 2 is a front perspective view of an embodiment of a thin plastic casing formed by a surface film according to the present invention;

FIG. 3 is a rear perspective view of the embodiment in FIG. 2 according to the present invention;

FIG. 4 is a schematic drawing showing a cross section of the embodiment shown in FIG. 2 and FIG. 3 according to the present invention;

FIG. 5 is a schematic drawing showing a cross section of a surface film applied to an injection mold of a thin plastic casing composite according to the present invention;

FIG. 6 is a partial enlarged view a cross section of the injection mold shown in FIG. 6 and injection material for a thin plastic casing is fixed on an surface film according to the present invention;

FIG. 7 is a schematic drawing showing a side view of a machine of the injection mold in FIG. 5 with three elastic pressure columns used as positioning points according to the present invention;

FIG. 8 is a flow chart showing steps a surface film of the present invention applied to a thin plastic casing composite.

### DETAILED DESCRIPTION OF THE PREFERRED EMBODIMENT

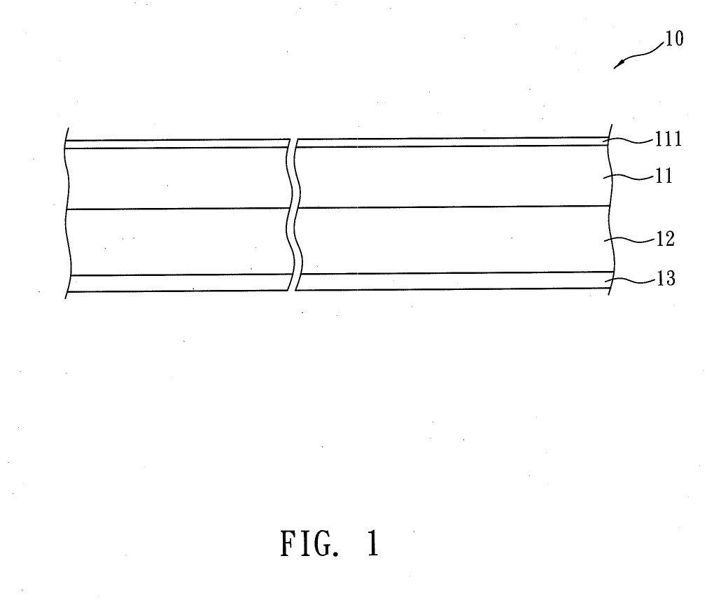

Refer to FIG. 1, a surface film 10 of a thin plastic casing composite of the present invention includes a decorative outer layer 11, an intermediate absorption and heat insulation layer 12 and an inner adhesive layer 13. The decorative outer layer 11 is arranged outside for display. The intermediate absorption and heat insulation layer 12 is disposed between the decorative outer layer 11 and the inner adhesive layer 13 and is adhered to and integrated with the decorative outer layer 11. The inner adhesive layer 13 is set on an inner surface and a thin plastic casing is formed on the surface thereof. The decorative outer layer 11, the intermediate absorption and heat insulation layer 12 and the inner adhesive layer 13 are laminated in sequence to form a thin film.

The decorative outer layer 11 is one of the followings: a fabric layer, a synthetic leather layer, a carbon fiber layer or a glass fiber layer. The fabric layer is formed by natural fiber such as vegetable fiber (cotton or hemp) or animal fiber (wool or silk). The synthetic leather layer is made from polyurethane (PU), polyvinyl chloride (PVC), or PU together with PVC. The carbon fiber layer is made from carbon fiber and the glass fiber layer is formed by glass fiber. The thickness of the decorative outer layer 11 is about 0.2-0.6 mm.

The intermediate heat absorption and insulation layer 12 is made from polyester (tetoron), nylon or blends and is with a thickness of about 0.2-0.5 mm. The materials for the intermediate heat absorption and insulation layer 12 are not heat-resistant. Their heat resistance is much lower than the heat resistance of the plastic film (IMD film) made from PET. Moreover, the intermediate heat absorption and insulation layer 12 is in the form of woven fabric, non-woven fabric, a foam layer or a microfiber layer. It is preferred that the intermediate heat absorption and insulation layer 12 is of high density and the structure thereof is with micro pores.

The inner adhesive layer 13 is a thermoplastic rubber layer synthesized by butadiene-styrene block copolymer and hydrocarbon petroleum resin with a thickness of about 40-60 μm.

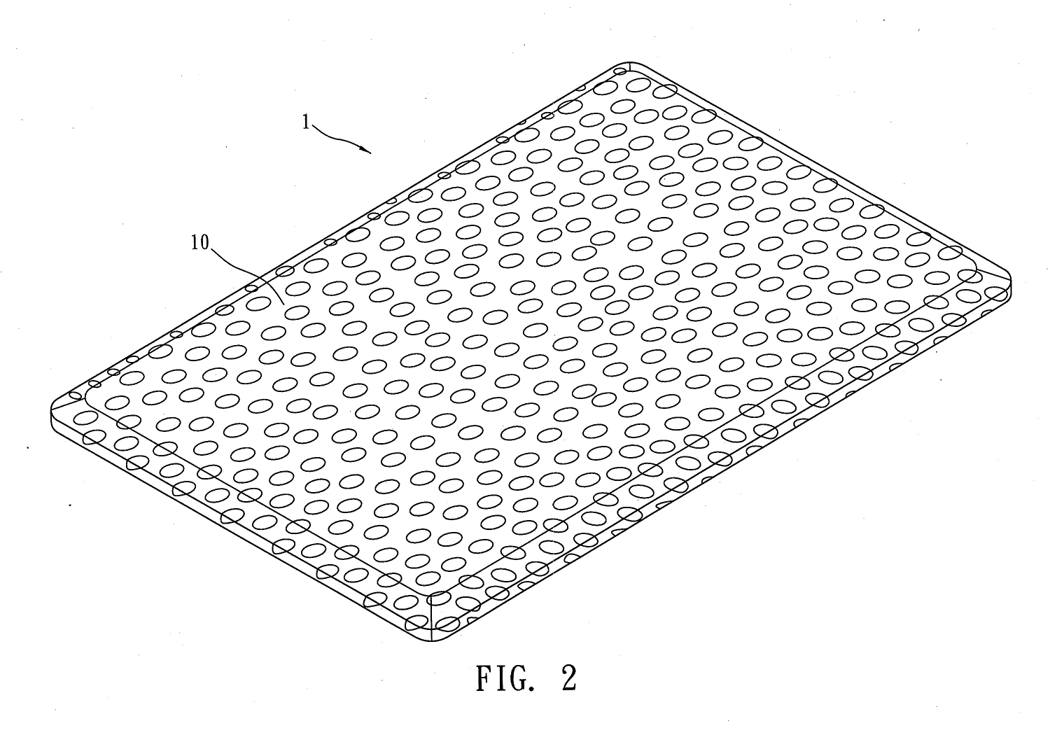

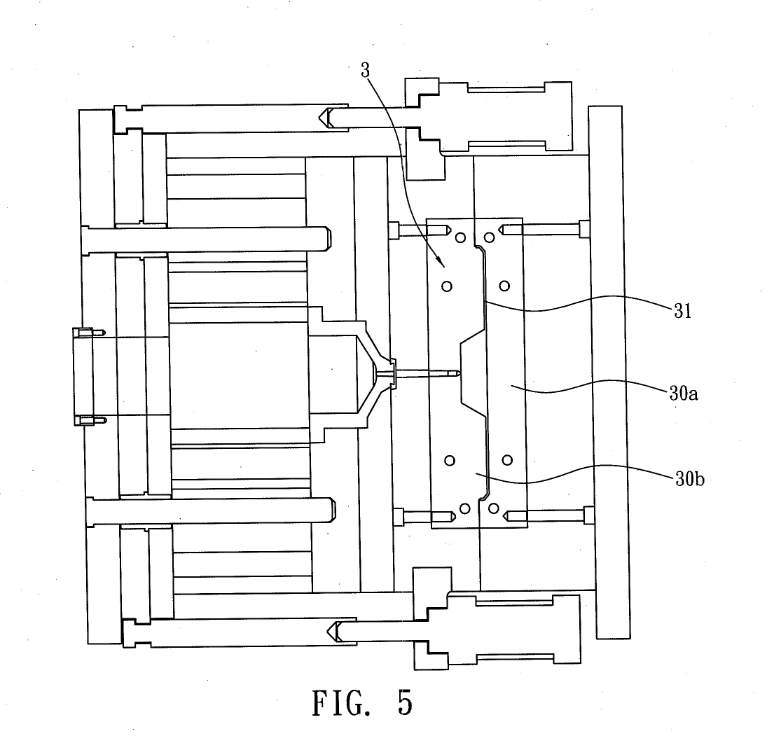

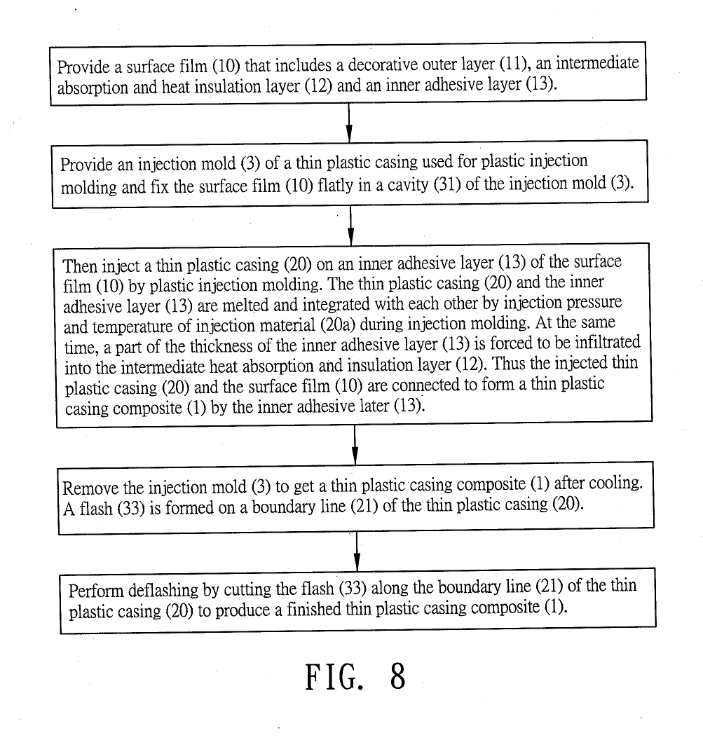

Refer to FIG. 8, an application method of a surface film 10 of a thin plastic casing composite of the present invention is described in details. At the same time, the structural features of the thin plastic casing composite 1 and an injection mold 3 thereof produced by the surface film 10 are also explained. Refer from FIG. 2 to FIG. 4, a front view, rear perspective view and a cross sectional view of a thin plastic casing composite 1 produced by the surface film 10 of the present invention are revealed. Refer from FIG. 5 to FIG. 7, a cross sectional view, a partial enlarged view of a cross section of a surface film 10 applied to an injection mold 3 of a thin plastic casing composite 1, and a side view of a machine of the injection mold with three elastic pressure columns used as positioning points are disclosed.

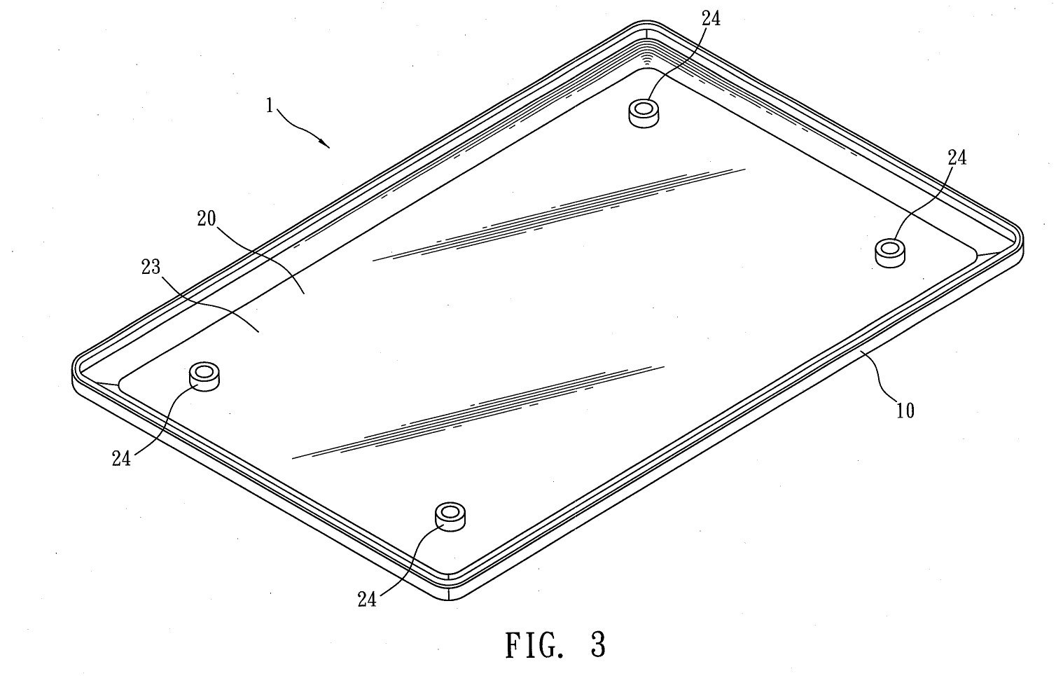

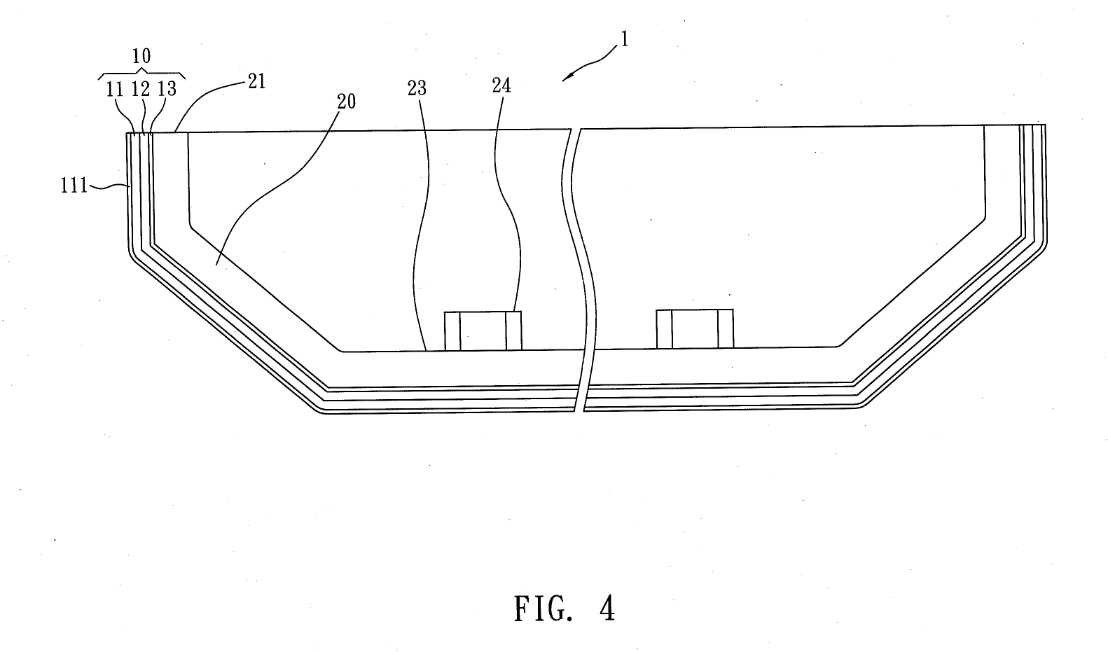

Refer to FIG. 8, an application method of a surface film 10 to produce a thin plastic casing composite 1 of the present invention includes following steps. Provide a surface film 10 of the present invention. The surface film 10 is a decorative film layer disposed on an outer surface of a plastic housing of a product. In the present invention, the surface film 10 is arranged at an outer surface of a thin plastic casing composite 1. The product is an electronic, a lamp or construction material with a housing. The electronic further includes, but not limited to, 3C products formed by computers such as notebooks, communication products such as mobile phones or consumer products. Take a thin plastic housing of a notebook that is a thin plastic casing composite 1 as an example, as shown in FIG. 2, FIG. 3 and FIG. 4. The surface film 10 includes a decorative outer layer 11, an intermediate absorption and heat insulation layer 12 and an inner adhesive layer 13 from outside to inside. According to requirements in practice, the intermediate heat absorption and insulation layer 12 is adhered to and integrated with the decorative outer layer 11 by a thin layer of glue. Then the decorative outer layer 11 with the intermediate absorption and heat insulation layer 12 and the inner adhesive layer 13 are stacked and laminated to form a thin film. An outer surface of the surface film 10, an outer surface of the decorative outer layer 11, is processed to have a transparent protection film 111 for protecting the decorative outer layer 11 and changing patterns, gloss and the sense of touch of the decorative outer layer 11. Thus the diversity of the decorative outer layer 11 is increased. While in use, the surface film 10 is made into a long strip with a certain width and rolled into a roll so as to be delivered to a working platform of a machine by a conveyor and cut into pieces used for following processes.

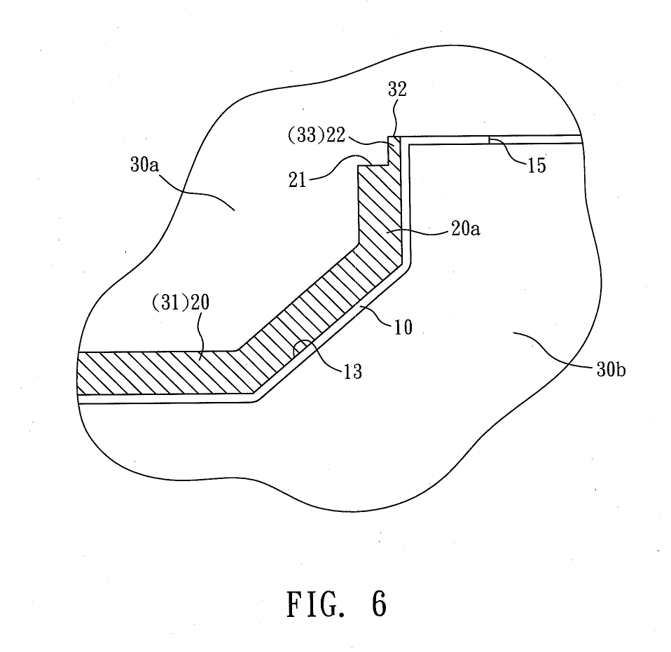

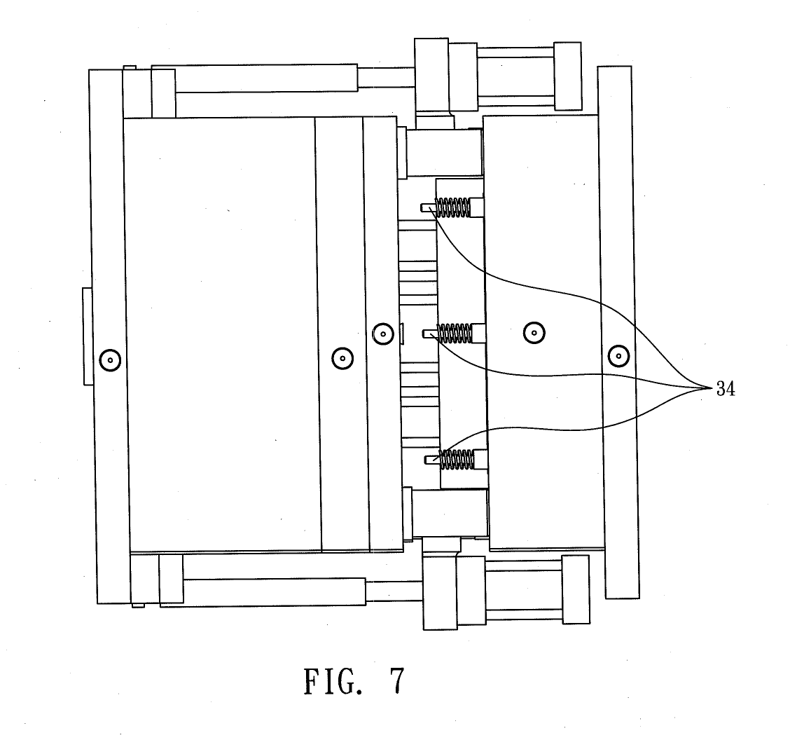

Then provide an injection mold 3 of a thin plastic casing 20 used for plastic injection molding. Refer to FIG. 5 and FIG. 6, the surface film 10 is fixed in a cavity 31 of the injection mold 3 flatly. The injection mold 3 is designed according to requirements of the plastic injection molding. There are no restrictions on the structure and arrangement of pouring openings, channels for conveying injection material, etc. After the surface film 10 being fixed into the cavity 31, an outer periphery 15 of the surface film 10 is over an outer boundary 32 of the cavity 31. Moreover, the outer boundary 32 of the cavity 31 is over a boundary line (or peripheral end surface) 21 of the thin plastic casing 20 to form a material overflow area 33 that is thin and around a periphery of the projection mold 3. There is a drop height between the material overflow area 33 and the boundary line 21 of the thin plastic casing 20, as shown in FIG. 6. Moreover, refer to FIG. 7, a plurality of elastic pressure column 34 used as positioning points is arranged around a periphery of the cavity 31. The number of the elastic pressure column 34 is not limited and there are three elastic pressure columns 34 on a single side shown in FIG. 7. The edge of the surface film 10 is clipped and supported elastically by the plurality of elastic pressure columns 34 so as to keep the surface film 10 set in the cavity in a flat state without wrinkles while male/female molds 30a, 30b being closed.

Next inject a thin plastic casing 20 on an inner surface of the surface film 10 (the inner adhesive layer 13) by plastic injection molding. The thin plastic casing 20 and the inner adhesive layer 13 are melted and integrated with each other by injection pressure and temperature of injection material 20a during injection molding. At the same time, a part of the thickness (about 10-20%, 4-12 μm) of the inner adhesive layer 13 (with the thickness of 40-60 μm) is forced to be infiltrated into the existing pores of the intermediate heat absorption and insulation layer 12. This effectively redistributes the injection pressure and temperature of the injection material 20a. That means the intermediate heat absorption and insulation layer 12 absorbs a part of thickness of the inner adhesive layer 13 by the existing pores in the structure thereof and also insulates the injection pressure and temperature of the injection material 20a by a certain density of the structure thereof. Thus the injection pressure and temperature of the injection material 20a are redistributed so as to prevent the integrity of the decorative outer layer 11 from being damaged by injection pressure and temperature of the injection material 20a. Moreover, during the injection molding, flowing of the injection material 20a also forces the surface film in a flat state. Thus a thin plastic casing composite 1 with good adhesion strength and good quality is formed.

The material overflow area 33 extends outward from the boundary line 21 of the thin plastic casing 20 to form a thinner flange 22, as shown in FIG. 6. That means the thinner flange 22 is formed integrally on the edge of the injected thin plastic casing 20 before deflashing. The flange 22 is a preset flash of the thin plastic casing 20 that is going to be removed by following operations. Furthermore, if users intend to install electric components such as circuit board on an inner surface 23 of the injected thin plastic casing 20, connection parts 24 (as shown in FIG. 3, FIG. 4) required for installation are also injected to and formed on the inner surface 23 of the thin plastic casing 20 while the thin plastic casing 20 being injected. Thus both the connection parts 24 and the thin plastic casing 20 are injected at the same time to form an integral structure.

After cooling, remove the injection mold 30 to get a thin plastic casing composite 1.

Then perform deflashing by cutting the flange 22 (shown in FIG. 6) formed by the material overflow area 33 of the cavity 31 along the boundary line 21 of the thin plastic casing 20 to produce a final product-a thin plastic casing composite 1 having the surface film 10 and the thin plastic casing 20 integrated with each other, as shown from FIG. 2 to FIG. 4.

In an application method that uses a surface film 10 to produce a thin plastic casing composite 1 according to the present invention, the adhesion and connection between the surface film 10 and the thin plastic casing 20 are quite good because that a part of the thickness of the inner adhesive layer 13 of the surface film 10 is infiltrated into the existing pores in the intermediate heat absorption and insulation layer 12 and the inner adhesive layer 13 is also melted and integrated with the thin plastic casing 20 at the same time. After being tested, it is proved that the surface film 10 has sufficient peel resistance. Thus the surface film 10 of the present invention can increase structure strength of the integral thin plastic casing composite 1 formed.

Moreover, in the application method of the surface film 10 of the present invention, a peripheral and thinner material overflow area 33 is designed on edge of an outer boundary 32 of the cavity 31. During injection molding, the injection material 20a generally enters the cavity 31 through a center area of the cavity 31. That means the pouring opening is arranged at the center of the cavity 31. Then the injection material 20a flows radially and faster toward the outer boundary 32 of the cavity 31. That means while the injection material 20a flows from the center toward the outer boundary 32, it also presses the outer film 10 on the outer boundary 32 so that the flowing of the injection material 20a forces the outer film 10 on the outer boundary 32 to extend outward. Thus a straightening effect from inward to outward is generated and is extended to the material overflow area 33, the outer boundary 32 of the cavity 31. Thus the outer film 10 around the thinner flange 22 on the edge of the injected thin plastic casing 20 is getting more dense and straightened. After the flange 22 (flash) being removed, the periphery of the product is more flat and the product quality is improved

According to the design of the surface film 10, it is set into a mold directly for injection molding of the thin plastic casing 20. It also redistributes the injection pressure and temperature of the injection material 20a so as to prevent the decorative outer layer 11 from being damaged by the injection pressure and temperature of the injection material 20a. The decorative outer layer 11 can be a fabric layer or a synthetic leather layer made from various materials. The fabric layer is made from natural fiber or artificial fiber while the synthetic leather layer is made from PU, PVC, OR PU together with PVC. A thin plastic casing composite 1 with good quality is produced by plastic injection molding. Thus a purpose of simplified manufacturing processes is achieved.

In the application of the surface film 10 of the present invention, the injection material 20a for the thin plastic casing 20 includes a plurality kinds of plastic such as acrylonitrile butadiene styrene (ABS), polycarbonate resin (PC), acrylic resin, polyamide resin (nylon), etc. The pressure and temperature of the injection materials 20a are as followings: 80 kg/mm² and 200° C. for ABS, 120 kg/mm² and 260° C. for PC, 100 kg/mm² and 240° C. for acrylic resin and 80 kg/mm² and 260° C. for nylon. By the injection pressure and temperature of the injection material 20a, the thin plastic casing 20 and the inner adhesive layer 13 of the surface film 10 are melted and connected to form an integral part. At the same time, about a part (10-20%) of the inner adhesive layer 13 with the thickness of 40-60 μm, 4-12 μm, is infiltrated into the existing pores of the intermediate heat absorption and insulation layer 12.

Furthermore, the surface film 10 of the present invention can be applied to plastic compression molding. The surface film 10 is set into a cavity of a compression mold. Then a thin plastic casing is formed on the inner adhesive layer 13 of the surface film 10 by compression and a continuous integral composite is produced. The plastic compression molding technique is similar to the plastic injection molding technique.

An application method of the present invention and its functions are further described in details by following embodiments.

### Embodiment One

In this embodiment, a decorative outer layer 11 of a surface film 10 is a leather layer made from PU, PVC or synthetic leather of PU and PVC and with a thickness of 0.2-0.3 mm. The decorative outer layer 11 is opaque and is processed to form patterns on surface thereof. An intermediate heat absorption and insulation layer 12 is made from polyester (tetoron), nylon or blends, with a thickness of 0.35-0.45 mm, and woven into fabric. An inner adhesive layer 13 is a thermoplastic rubber layer synthesized by butadiene-styrene block copolymer and hydrocarbon petroleum resin with a thickness of 40-50 μm (0.04-0.05 mm). The injection material 20a for a thin plastic casing 20 is PC or ABS and is injected to an inner surface of the surface film 10 (the inner adhesive layer 13) by plastic injection molding. The thickness of the thin plastic casing 20 is 2 mm while the length and width thereof are respectively 262 mm and 178 mm. Moreover, an inner surface 23 of the thin plastic casing 20 is arranged with a plurality of connection parts 24 that are injected together with the thin plastic casing 20 and with the height of 9.5 mm. After being tested, the peel strength adhesion between the surface film 10 and the thin plastic casing 20 of this embodiment is 8 kg/cm². In the environmental testing with adhesion testing, the operating temperature is increasing/decreasing 1° C. each min from −40° C. to 85° C./from 85° C. to −40° C. and there are four cycles. The surface film 10 is not peeled off from the thin plastic casing 20. Thus the surface film 10 of the present invention surely improves the structure strength and the adhesion an integral thin plastic casing composite 1 formed by the surface film 10 and the thin plastic casing 20.

### Embodiment Two

In this embodiment, a decorative outer layer 11 of a surface film 10 is a leather layer made from PU, PVC or synthetic leather of PU and PVC, the same with the embodiment one and with a thickness of 0.4-0.5 mm. Yet an outer surface of the decorative outer layer 11 is a transparent and smooth surface while an inner surface thereof is processed to form patterns and is colored by electroplate. An intermediate heat absorption and insulation layer 12 is made from polyester (tetoron), nylon or blends, with a thickness of 0.35-0.45 mm, and woven into fabric as the embodiment one. An inner adhesive layer 13 is a thermoplastic rubber layer synthesized by butadiene-styrene block copolymer and hydrocarbon petroleum resin with a thickness of 30-40 μm (0.03-0.04 mm). The injection material 20a for a thin plastic casing 20 is PC or ABS and is injected to an inner surface of the surface film 10 (the inner adhesive layer 13) by plastic injection molding to form the thin plastic casing 20. The thickness of the thin plastic casing 20 is 2 mm while the length and width thereof are respectively 262 mm and 178 mm. Moreover, an inner surface 23 of the thin plastic casing 20 is disposed with a plurality of connection parts 24 that are injected together with the thin plastic casing 20 and with the height of 9.5 mm. After being tested, the peel strength adhesion between the surface film 10 and the thin plastic casing 20 of this embodiment is 8 kg/cm². In the environmental testing with adhesion testing, the operating temperature is increasing/decreasing 1° C. each min from −40° C. to 85° C./from 85° C. to −40° C. and there are four cycles. The surface film 10 is not peeled off from the thin plastic casing 20. Thus the surface film 10 of the present invention really improves the structure strength and the adhesion an integral thin plastic casing composite 1 formed by the surface film 10 and the thin plastic casing 20.

### Embodiment Three

In this embodiment, a decorative outer layer 11 of a surface film 10 is a leather layer made from PU, PVC or synthetic leather of PU and PVC and with a thickness of 0.2-0.3 mm. The decorative outer layer 11 is opaque and is processed to form patterns on surface thereof. An intermediate heat absorption and insulation layer 12 is made from polyester (tetoron), nylon or blends and with a thickness of 0.35-0.45 mm. The intermediate heat absorption and insulation layer 12 is in the form of woven fabric, non-woven fabric, a foam layer or a microfiber layer. An inner adhesive layer 13 is a thermoplastic rubber layer synthesized by butadiene-styrene block copolymer and hydrocarbon petroleum resin with a thickness of 40-50 μm (0.04-0.05 mm). The injection material 20a for a thin plastic casing 20 is PC or ABS and is injected to an inner surface of the surface film 10 (the inner adhesive layer 13) by plastic injection molding to form the thin plastic casing 20. The thickness of the thin plastic casing 20 is 2 mm while the length and width thereof are respectively 262 mm and 178 mm. Moreover, a plurality of connection parts 24 with the height of 9.5 mm is disposed on an inner surface 23 of the thin plastic casing 20 and is injected together with the thin plastic casing 20. After being tested, the peel strength adhesion between the surface film 10 and the thin plastic casing 20 of this embodiment is 8 kg/cm². In the environmental testing with adhesion testing, the operating temperature is increasing/decreasing 1° C. each min from −40° C. to 85° C./from 85° C. to −40° C. and there are four cycles. The surface film 10 is not peeled off from the thin plastic casing 20. Thus the surface film 10 of the present invention really improves the structure strength and the adhesion an integral thin plastic casing composite 1 formed by the surface film 10 and the thin plastic casing 20.

### Embodiment Four

In this embodiment, a decorative outer layer 11 of a surface film 10 is a fabric layer made from artificial fiber such as nylon, polyester, acrylic fiber or blends and with a thickness of 0.2-0.3 mm. An intermediate heat absorption and insulation layer 12 is made from polyester (tetoron), nylon or blends and with a thickness of 0.35-0.45 mm. The intermediate heat absorption and insulation layer 12 is in the form of woven fabric, non-woven fabric, a foam layer or a microfiber layer. An inner adhesive layer 13 is a thermoplastic rubber layer synthesized by butadiene-styrene block copolymer and hydrocarbon petroleum resin with a thickness of 40-50 μm (0.04-0.05 mm). The injection material 20a for a thin plastic casing 20 is PC or ABS and is injected to an inner surface of the surface film 10 (the inner adhesive layer 13) by plastic injection molding to form the thin plastic casing 20. The thickness of the thin plastic casing 20 is 2 mm while the length and width thereof are respectively 262 mm and 178 mm. Moreover, a plurality of connection parts 24 with the height of 9.5 mm is disposed on an inner surface 23 of the thin plastic casing 20 and is injected together with the thin plastic casing 20. After being tested, the peel strength adhesion between the surface film 10 and the thin plastic casing 20 of this embodiment is 8 kg/cm². In the environmental testing with adhesion testing, the operating temperature is increasing/decreasing 1° C. each min from −40° C. to 85° C./from 85° C. to −40° C. and there are four cycles. The surface film 10 is not peeled off from the thin plastic casing 20. Thus the surface film 10 of the present invention really improves the structure strength and the adhesion an integral thin plastic casing composite 1 formed by the surface film 10 and the thin plastic casing 20.

### Embodiment Five

In this embodiment, a decorative outer layer 11 of a surface film 10 includes a fabric layer, a glue layer and a transparent resin coating layer. The fabric layer is made from artificial fiber such as nylon, polyester, acrylic fiber or blends and with a thickness of 0.2-0.3 mm. The glue layer with a thickness of 0.04-0.06 mm is used to connect the fabric layer and the transparent resin coating layer. The transparent resin coating layer with a thickness of 0.1-0.2 mm is attached to an outer surface of the fabric layer. Thus the decorative outer layer 11 formed is with a thickness of 0.34-0.56 mm.

An intermediate heat absorption and insulation layer 12 is made from polyester (tetoron), nylon or blends, with a thickness of 0.35-0.45 mm. The intermediate heat absorption and insulation layer 12 is in the form of woven fabric, non-woven fabric, a foam layer or a microfiber layer. An inner adhesive layer 13 is a thermoplastic rubber layer synthesized by butadiene-styrene block copolymer and hydrocarbon petroleum resin with a thickness of 40-50 μm (0.04-0.05 mm). The injection material 20a for a thin plastic casing 20 is PC or ABS and is injected to an inner surface of the surface film 10 (the inner adhesive layer 13) by plastic injection molding to form the thin plastic casing 20. The thickness of the thin plastic casing 20 is 2 mm while the length and width thereof are respectively 262 mm and 178 mm. Moreover, a plurality of connection parts 24 with the height of 9.5 mm is disposed on an inner surface 23 of the thin plastic casing 20 and is injected together with the thin plastic casing 20. After being tested, the peel strength adhesion between the surface film 10 and the thin plastic casing 20 of this embodiment is 8 kg/cm². In the environmental testing with adhesion testing, the operating temperature is increasing/decreasing 1° C. each min from −40° C. to 85° C./from 85° C. to −40° C. and there are four cycles. The surface film 10 is not peeled off from the thin plastic casing 20. Thus the surface film 10 of the present invention surely improves the structure strength and the adhesion an integral thin plastic casing composite 1 formed by the surface film 10 and the thin plastic casing 20.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

1. A surface film of a thin plastic casing composite to be set into a cavity of a plastic injection mold for producing an integral thin plastic casing composite with the surface film and a thin plastic casing comprising: a decorative outer layer, an intermediate heat absorption and insulation layer and an inner adhesive layer from outside to inside in turn; wherein the decorative outer layer is a fabric layer made from natural or artificial fiber, a synthetic leather layer formed by a synthetic leather, a carbon fiber layer made from carbon fiber or a glass fiber layer formed by glass fiber and having a thickness of about 0.2-0.6 mm;
the intermediate heat absorption and insulation layer is made from polyester (tetoron), nylon or blends and is with a thickness of about 0.2-0.5 mm;
the inner adhesive layer is a thermoplastic rubber layer synthesized by butadiene-styrene block copolymer and hydrocarbon petroleum resin with a thickness of about 40-60 μm;
wherein the surface film is set in a cavity of an injection mold while in use and then a thin plastic casing is injected onto the inner adhesive layer of the surface film so as to produce a thin plastic casing composite having the surface film and the thin plastic casing;
the thin plastic casing and the inner adhesive layer are melted and integrated with each other by injection pressure and temperature of injection material during injection molding while a part of thickness of the inner adhesive layer is simultaneously forced to be infiltrated into the intermediate heat absorption and insulation layer to redistribute the injection pressure and temperature of the injection material; thus the thin plastic casing and the surface film are connected by the inner adhesive layer to form an integral thin plastic casing composite.

2. The device as claimed in claim 1, wherein the intermediate heat absorption and insulation layer is in the form of woven fabric, non-woven fabric, a foam layer or a microfiber layer.

3. The device as claimed in claim 2, wherein the intermediate heat absorption and insulation layer and the decorative outer layer are adhered and integrated with each other.

4. The device as claimed in claim 1, wherein the inner adhesive layer is attached to an inner surface of the intermediate heat absorption and insulation layer by a pressing of a roller.

5. The device as claimed in claim 1, wherein the part of the thickness of the inner adhesive layer is about 10-20% of the thickness of the inner adhesive layer and is ranging from 4 to 12 μm.

6. The device as claimed in claim 1, wherein the decorative outer layer is a fabric layer made from natural fiber including vegetable fiber such as cotton, or hemp, or animal fiber such as wool or silk.

7. The device as claimed in claim 1, wherein the decorative outer layer is a fabric layer made from artificial fiber including nylon, polyester, acrylic fiber or blends.

8. The device as claimed in claim 1, wherein the decorative outer layer is a synthetic leather layer made from polyurethane (PU), polyvinyl chloride (PVC), or PU together with PVC.

9. The device as claimed in claim 1 wherein the injection material for the thin plastic casing is selected from the group consisting of acrylonitrile butadiene styrene (ABS), polycarbonate resin (PC), acrylic resin, and nylon (polyamide resin).

10. The device as claimed in claim 1, wherein an outer periphery of the surface film is over an outer boundary of the cavity of the thin plastic casing when the surface film is set into the cavity.

11. The device as claimed in claim 1, wherein a flash is formed on the thin plastic casing after injection molding and is formed by a peripheral and thinner material overflow area and formed due to an outer boundary of the cavity over a boundary line of the thin plastic casing.

12. An application method of a surface film of a thin plastic casing composite used to produce an integral thin plastic casing composite having the surface film and a thin plastic casing comprising the steps of:
providing a surface film as claimed in claim 1 having a decorative outer layer, an intermediate absorption and heat insulation layer and an inner adhesive layer;
providing an injection mold of a thin plastic casing used for plastic injection molding and fixing the surface film flatly in a cavity of the injection mold;
injecting a thin plastic casing on an inner adhesive layer of the surface film by plastic injection molding; wherein the thin plastic casing and the inner adhesive layer are melted and integrated with each other by injection pressure and temperature of injection material during injection molding while a part of the thickness of the inner adhesive layer is forced to be infiltrated into the intermediate heat absorption and insulation layer simultaneously so that the injected thin plastic casing and the surface film are connected to form a thin plastic casing composite by the inner adhesive layer;
removing the injection mold to get a thin plastic casing composite after cooling and a flash is formed on a boundary line of the thin plastic casing; and
performing deflashing by cutting the flash along the boundary line of the thin plastic casing to produce a finished thin plastic casing composite.

13. The method as claimed in claim 12, wherein an outer periphery of the surface film is over an outer boundary of the cavity when the surface film is set into the cavity.

14. The method as claimed in claim 12, wherein the flash is formed by a peripheral and thinner material overflow area formed due to an outer boundary of the cavity over a boundary line of the thin plastic casing.
